(19) United States
(12) Patent Application Publication
(10) Pub. No.: US 2001/0020239 A1
(43) Pub. Date: Sep. 6, 2001

(54) Business card managing system

(75) Inventors: Kazunori Ukigawa, Tokushima (JP); Hiroki Yamashita, Chiba (JP); Akira Yamada, Tokushima (JP)

Correspondence Address: McDermott, Will & Emery, 600 13th Street, N.W., Washington, DC, 20005-3096, US

(73) Assignee: Justsystem Corporation

(21) Appl. No.: 09/793,577

(22) Filed: Feb. 27, 2001

(30) Foreign Application Priority Data
Mar. 1, 2000 (JP) 2000-56411

(51) Int. Cl. G06F 17/30; G06K 5/00

(52) U.S. Cl. 707/104.1; 235/380; 707/10

(57) ABSTRACT

When persons who meet each other in the business scene exchange their business cards, and business card IDs specific to themselves and send the obtained other person's business card ID together with information indicating the situation when the IDs are exchanged, from the cellular phones to register the ID in the business card managing server. The business card managing server includes user's own information databases, besides other persons' information databases. A user who intends to browse another person's business card information, sends the user's own business card ID and the other person's business card ID to the business card managing server from the business card managing client. The business card managing server retrieves necessary information from the other persons' information database of the user and the user's own information database of the other person, and sends retrieved information to the business card managing client as the business card information.

### BACKGROUND OF THE INVENTION

1. Field of the Invention

The present invention relates to a technology to manage business cards and other information unitarily in a server in a business card managing system.

2. Description of the Related Art

In the business scene, business cards are widely used as a means to identify oneself. Normally, persons who meet each other for the first time in the business scene exchange their business cards. Each of the persons obtains only one business card from the other, and the obtainers manage the other person's information by the one business card. However, for a person who has exchanged business cards with many persons, it is difficult to manage obtained other persons' business cards because the person has many business cards to be managed. And it is difficult for persons other than the person, who exchanged business cards, such as a secretary to manage the other persons' information because there is only one business card for one person.

Business card managing tools have been conventionally provided as a kind of application programs used in personal computers and the like, for realizing simple management of information of other persons with whom one exchanged business cards. With the use of the business card managing tools, business card information (information described on business cards and other information unitarily managed with the above information) of many persons can be easily managed. By inputting information of a person based on his/her business card, a plurality of persons can see his/her information.

However, users of the business card managing tools need to input other persons' information described on the business cards from a keyboard and the like. Therefore, those business card managing tools have a problem of costing users much time to input information.

Some of the business card managing tools have a function to store additional information other than information described on the business cards. However, such additional information is to be input later on, not at the time when business cards are exchanged. Due to this, at the time of inputting additional information such as the date and situation on and in which the business cards were exchanged, users of the business card managing tools cannot remember the situation clearly, so they sometimes cannot input additional information accurately.

If the condition of a person whose information is managed by one user, changes due to promotion, transfer, changing jobs, and the like, the user cannot obtain information regarding the new conditions, unless the user hears from the person. Even if the user obtains the new information, he/she needs to input the new information from the keyboard and the like, and has to take time to input the new information.

A person who gave business cards to other persons does not have a means to know by whom and how the person's information managed by other persons' business card managing tools is referred to. Therefore, a person who gave business cards to other persons cannot present further information of the person safely to other persons.

### SUMMARY OF THE INVENTION

It is an object of this invention to easily manage information based on a plurality of business cards, with the use of the business card managing system.

It is another object of this invention to securely manage the situation when business cards were exchanged, with the use of the business card managing system.

It is another object of this invention to manage information, following changes in the condition which happen after the exchange of business cards, with the use of the business card managing system.

It is another object of this invention to enhance the security of personal information when his/her information is provided to another person who uses the business card managing system.

To achieve the above objects, the business card managing system according to the first aspect of the present invention comprises a server device, and a plurality of first terminal devices and second terminal devices both of which are connected to the server device through a communication network, and at least one of each of which each user uses, wherein:

the server device comprises:

user's own information storing means for storing an ID of each user and information regarding the user;

first another person's ID receiving means for receiving another persons' ID transmitted from one of the first terminal devices;

a plurality of other persons' information storing means which are respectively set up for each user and are for storing other persons' IDs which the first another person's ID receiving means receives, in connection with information regarding the other persons;

second another person's ID receiving means for receiving another persons' ID transmitted from one of the second terminal devices;

information retrieving means for retrieving information from the user's own information storing means which corresponds to another person's ID which the second another person's ID receiving means receives, and for retrieving information stored in the other persons' information storing means of the user in connection with the other person's ID; and

information transmitting means for transmitting information retrieved by the information retrieving means, to one of the second terminal devices that transmitted the other person's ID, through the communication network,

each of the plurality of the first terminal devices comprises:

first another person's ID inputting means for inputting another person's ID which each user obtains; and

first another person's ID transmitting means for transmitting another person's ID input from the first another person's ID inputting means, to the first another person's ID receiving means through the communication network,

each of the plurality of the second terminal devices comprises:

second another person's ID inputting means for inputting another person's ID which corresponds to a person whose information the user wants to obtain;

second another person's ID transmitting means for transmitting another person's ID input from the second another person's ID inputting means, to the second another person's ID receiving means through the communication network;

information receiving means for receiving information transmitted from the information transmitting means of the server device in response to the transmission of another person's ID from the second another person's ID transmitting means; and

information outputting means for outputting information which the information receiving means receives.

In the business card managing system according to the first aspect of this invention, a user obtains another person's ID and transmits the ID from a first terminal device to the server device to store the ID in the other persons' information storing means. After this, the user can obtain information regarding the other person by transmitting the other person's ID from the second terminal device to the server device. Due to this, it is possible for each user to manage information regarding other persons without taking time to input information regarding the other persons.

In the business card managing system according to the first aspect of this invention,

each of the plurality of the second terminal devices may further comprise:

user's own information inputting means for inputting information regarding the user; and

user's own information transmitting means for transmitting information regarding the user input from the user's own information inputting means, to the server device through the communication network,

the server device may further comprise user's own information receiving means for receiving information regarding the user transmitted from the user's own information transmitting means.

In this case, the user's own information storing means may store information regarding the user which the user's own information receiving means receives, in connection with each user's ID.

In this case, if the condition of a user changes, the user transmits the new information indicative of the change from the second terminal device to the server device to register the change in the user's own information storing means. Other users who have obtained the user's ID can obtain the new information by transmitting the user's ID from the second terminal device to the server device. Due to this, each user can obtain other user's information which follows the change in the condition without inputting new information by himself/herself.

In the business card managing system according to the first aspect of this invention, each of the plurality of the first terminal devices may further comprise another person's information inputting means for inputting information regarding another person whose ID the user obtained.

In this case,

the first another person's ID transmitting means may transmit information regarding another person input from the another person's information inputting means, together with the other person's ID;

the first another person's ID receiving means may receive information regarding another person transmitted from the first another person's ID transmitting means, together with the other person's ID; and

the other persons' information storing means of the user whose first terminal device has transmitted the other person's ID, may store the other person's ID and information regarding the other person which the first another person's ID receiving means receives.

In this case, a user who obtained another person's ID can transmit information regarding the other person from the first terminal device to the server device at the time when the user obtained the other person's ID and register the ID in the other persons' information storing means. Due to this, each user can store the situation when each user meets another user precisely and refer to the stored situation later on.

In the business card managing system according to the first aspect of this invention, each of the plurality of the first terminal devices may further comprise communication means for directly transmitting and receiving information to/from other first terminal devices.

In this case, the first another person's ID inputting means may input, as another person's ID which the user obtained, another person's ID which the communication means receives from the communication means of another first terminal device.

In the business card managing system according to the first aspect of this invention, the server device may further comprise ID transmitting means for transmitting an ID other than the user's, to one of the plurality of the first terminal devices through the communication network in response to the request.

In this case, the first another person's ID inputting means may input, as another person's ID which the user obtained, an ID transmitted form the ID transmitting means.

To achieve the above objects, the business card managing system according to the second aspect of this invention comprises a server device, and a plurality of first terminal devices and second terminal devices both of which are connected to the server device through a communication network, and at least one of each of which each user uses, wherein:

the server device comprises:

user's own information storing means for storing an ID of each user and information regarding the user;

first another person's ID receiving means for receiving another person's ID transmitted from the second terminal devices;

a plurality of other persons' information storing means which are respectively set up for each user and are for storing other persons' IDs which the first another person's ID receiving means receives, in connection with information regarding the other persons;

second another person's ID receiving means for receiving another persons' ID transmitted from one of the second terminal devices;

information retrieving means for retrieving information from the user's own information storing means which corresponds to another person's ID which the second another person's ID receiving means receives, and for retrieving information stored in the other persons' information storing means of the user in connection with the other person's ID; and

information transmitting means for transmitting information retrieved by the information retrieving means, to one of the second terminal devices that transmitted the other person's ID, through the communication network,

each of the plurality of the first terminal devices comprises:

first another person's ID inputting means for inputting another person's ID which each user obtains; and

other person's ID storing means for storing the other person's ID input from the first another person's ID inputting means, in a recording medium,

each of the plurality of the second terminal devices comprises:

another person's ID reading out means for reading out another person's ID stored in the recording medium;

first another person's ID transmitting means for transmitting the other person's ID read out by the another person's ID reading out means, to the first another person's ID receiving means through the communication network;

second another person's ID inputting means for inputting another person's ID which corresponds to a person whose information the user wants to obtain;

second another person's ID transmitting means for transmitting another person's ID input from the second another person's ID inputting means, to the second another person's ID receiving means through the communication network;

information receiving means for receiving information transmitted from the information transmitting means of the server device in response to the transmission of another person's ID from the second another person's ID transmitting means; and

information outputting means for outputting information which the information receiving means receives.

In the business card managing system according to the second aspect of this invention, the second another person's ID inputting means may input, as an ID of another person whose information the user wants to obtain, another person's ID read out by the another person's ID reading out means.

In the business card managing system according to the second aspect of this invention, each user can register a plurality of other persons' IDs simultaneously. Each user can browse information regarding a plurality of other persons whose IDs each user obtained, at a time, by simple operations.

In the business card managing system according to the first and second aspects of this invention,

the second another person's ID transmitting means may transmit the user's ID together with the input other person's ID;

the second another person's ID receiving means may receive the user's ID together with the other person's ID; and

the information retrieving means may retrieve information from the user's own information storing means and the other persons' information storing means which corresponds to the user's ID which the second another person's ID receiving means receives, in the case where the received other person's ID is stored in the other persons' information storing means.

In this case, each user can not obtain information regarding another person unless he/she has his/her own ID in addition to the other person's ID. Due to this, someone other than another person to whom a user gave his/her ID, can not easily obtain information regarding the user. Therefore, security on personal information is ensured.

In the business card managing system according to the first and second aspects of this invention, the server device may further comprise ID level storing means for storing another person's ID which each user obtains, in connection with an information disclosure level which the other person designates.

In this case:

information regarding the user stored in the user's own information storing means may be added with an information disclosure level; and

the information retrieving means may search the ID level storing means to retrieve information from the user's own information storing means, to the degree of an information disclosure level which corresponds to the received other person's ID.

In this case, each user can have control on to whom and to what degree each user's information is to be provided. Due to this, it is possible to prevent improper use of each user's information by a third party. Therefore, security on personal information is ensured.

In the business card managing system according to the first and second aspects of this invention, the other persons' information storing means may further store a log that the information retrieving means retrieves and the information transmitting means transmits information, in connection with another person's ID.

In this case:

each of the plurality of the second terminal devices may further comprise:

log request transmitting means for transmitting a request for browsing a log that information regarding the user was referred to, to the server device through the communication network;

log receiving means for receiving the log transmitted from the server device in response to the request transmitted from the log request transmitting means; and

log outputting means for outputting the log which the log receiving means receives,

the server device may further comprise:

log request receiving means for receiving the request transmitted from the log request transmitting means;

log acquiring means for acquiring the log which is stored in the other persons' information storing means of the other person, in connection with the user's ID corresponding to the request the log request receiving means received; and

log transmitting means for transmitting the log acquired by the log acquiring means, to the log receiving means through the communication network.

In this case, each user can obtain a log regarding by whom and to what degree his/her information was browsed. Due to this, each user can get a clue to know the importance degree of him/her to another person, from the log of browsing each user's information by the other person.

In the business card managing system according to the first and second aspects of this invention, each of the plurality of the first terminal devices may be constituted by a cellular phone, and each of the plurality of the first terminal devices may be constituted by a computer device which is physically the same as the plurality of the second terminal devices.

To achieve the above objects, the business card managing method which uses a communication network according to the third aspect of this invention, comprises:

first step of registering each user's information in connection with the user's ID, in a server device through the communication network;

second step of registering another person's ID obtained from him/her, in the server device through the communication network;

third step of transmitting the other person's ID obtained from him/her, to the server device through the communication network, in order to request to browse information regarding the other person which corresponds to the other person's ID;

fourth step of extracting information regarding the other person which is requested to be browsed, from information which the other person registered as the information regarding himself/herself in the first step, according to the other person's ID, when the server device receives the other person's ID transmitted in the third step;

fifth step of transmitting information regarding the other person extracted in the fourth step, from the server device to the user who requested to browse through the communication network; and

sixth step of outputting information regarding the other person in order to be browsed by the user who requested to browse, when the user received the information in the fifth step.

In the above business card managing method:

the second step may register information regarding the other person in the server device, together with the other person's ID; and

the fourth step may further extract information registered as information regarding the other person in the second step, according to the other person's ID which the server device received in response to the request of the third step.

To achieve the above objects, the business card managing method by which persons who confront each other can manage respective information, according to the fourth aspect of this invention comprises:

previously storing information regarding each person in connection with the person's ID in a database;

exchanging their IDs each other in the case they meet; and

accessing the database by using the ID obtained from the other person and obtaining information regarding the other person from the database.

The above business card managing method according to the fourth aspect of this invention may further comprise storing the exchanged IDs in the database in connection with each other, wherein

in the case where obtaining information regarding the other person from the database, the user's own ID may further be used.

The business card managing method according to the fourth aspect of this invention may further comprises storing the situation where the person obtained the ID in the database, at the time when the ID from the other person, wherein

in the case where obtaining information regarding the other person from the database, the situation where the person obtained the other person's ID may also be obtained.

In the business card managing method according to the fourth aspect of this invention:

information regarding the person stored in the database may be able to be renewed; and

in the case where obtaining information regarding the other person from the database, the latest renewed information may be able to be obtained.

In the business card managing method according to the fourth aspect of this invention:

each of the items contained in the information regarding the person may be designated a disclosure level and stored in the database with the disclosure level;

in the case where exchanging IDs, a disclosure level may be selected according to the other person; and

in the case where obtaining information regarding the other person from the database, information corresponding to the selected disclosure level may be able to be obtained.

In the business card managing method according to the fourth aspect of this invention:

each of the items contained in the information regarding the person may be designated whether or not to be provided to the agent of the other person with whom the person exchanged IDs, and stored in the database with the designation; and

in the case where obtaining information regarding the other person from the database, information designated to be provided to the agent may only be able to be obtained by the agent.

The business card managing method according to the fourth aspect of this invention may further comprise:

storing a log that information regarding the person was obtained from the database in the database; and

each person referring to a log that information regarding the person was obtained from the database.

In the business card managing method according to the fourth aspect of this invention, exchanging the IDs is implemented when each person meets the other person and exchanges their business cards in the business scene.

To achieve the above objects, the business card managing server device according to the fifth aspect of this invention, is connected to a plurality of terminal devices, each of which is used by a user for requesting information regarding another person, by transmitting the other person's ID, through a communication network, the server device comprising:

user's own information storing means for storing each user's ID and information regarding each user;

a plurality of other persons' information storing means which are respectively set up for each user for storing other persons' IDs which the user obtains, in connection with information regarding the other persons;

another person's ID receiving means for receiving another person's ID transmitted from one of the terminal devices;

information retrieving means for retrieving information from the user's own information storing means which corresponds to the other person's ID which the another person's ID receiving means receives, and for retrieving information stored in the other persons' information storing means of the user in connection with the other person's ID; and

information transmitting means for transmitting information retrieved by the information retrieving means, to the terminal device that transmitted the other person's ID through the communication network.

To achieve the above objects, the client device according to the sixth aspect of this invention, is connected to the server device according to the fifth aspect of this invention, and functions as one of the terminal devices, comprising:

another person's ID inputting means for inputting an ID of another person whose information the user wants to obtain;

another person's ID transmitting means for transmitting the other person's ID input from the another person's ID inputting means, to the another person's ID receiving means through the communication network;

information receiving means for receiving information transmitted from the information transmitting means of the server device in response to the transmission of the other person's ID from the another person's ID transmitting means; and

information outputting means for outputting information which the information receiving means receives.

To achieve the above objects, the portable terminal device according to the seventh aspect of this invention, is connected to the server device according to the fifth aspect of this invention, comprising;

another person's ID inputting means for inputting another person's ID which the user obtains; and

another person's ID transmitting means for transmitting the other person's ID input from the another person's ID inputting means, to the server device through the communication network, and storing the ID in the other persons' information storing means.

To achieve the above objects, the server device according to the eighth aspect of this invention, is connected to a plurality of terminal devices, each of which is used by a user for requesting information regarding another person, by transmitting the other person's ID, through a communication network, wherein:

the server device comprises:

a user's own information database for storing each user's ID and information regarding each user;

a plurality of other persons' information databases which are respectively set up for each user and are for storing other persons' IDs which each user obtains in connection with information regarding the other persons;

a communication device for processing communications between itself and the terminal devices through the communication network;

a memory which stores a program; and

a processor for accessing the user's own information database and the other persons' information databases, and for controlling the communication device, according to the program stored in the memory,

the processor executes the program to:

wait until the communication device receives another person's ID from one of the terminal devices;

retrieve information from the user's own information database which corresponds to the other person's ID, in response to the reception of the other person's ID by the communication device;

retrieve information which is in connection with the received other person's ID, from the other persons' information database of the user; and

control the communication device to transmit information retrieved from the user's own information database and the other persons' information database, to the terminal device that transmitted the other person's ID through the communication network.

To achieve the above objects, the client device according to the ninth aspect of this invention, is connected to the server device according to the eighth aspect of this invetnion, and functions as one of the terminal devices, wherein:

the client device comprises:

an inputting device for inputting information;

an outputting device for outputting information;

a communication device for processing communications between itself and the server device through the communication network;

a memory which stores a program; and

a processor for controlling the inputting device, the outputting device and the communication device according to the program stored in the memory,

the processor executes the program to:

control the inputting device to input an ID of another person whose information the user wants to obtain;

control the communication device to transmit the other person's ID input from the inputting device, to the server device through the communication network;

wait until the communication device receives information transmitted from the server device in response to the transmission of the other person's ID; and

control the outputting device to output information which the communication device receives.

To achieve the above objects, the portable terminal device according to the tenth aspect of this invention, is connected to the server device according to the eighth aspect of this invention, wherein:

the portable terminal device comprises:

an inputting device for inputting information;

a communication device for processing communications between itself and the server device through the communication network;

a memory which stores a program; and

a processor for controlling the inputting device, the outputting device and the communication device according to the program stored in the memory,

the processor executes the program to:

control the inputting device to input another person's ID which the user obtains; and

control the communication device to transmit the other person's ID input from the inputting device, to the server device through the communication network, in order to store the ID in the other persons' information database in the server device.

To achieve the above objects, in the computer-readable recording medium which stores a program, according to the eleventh aspect of this invention, the program controls a computer device which is connected to a plurality of terminal devices, each of which is used by a user for requesting information regarding another person by transmitting the other person's ID, through a communication network, to function as:

user's own information storing means for storing each user's ID and information regarding each user;

a plurality of other persons' information storing means which are respectively set up for each user and are for storing other persons' IDs which each user obtains, in connection with information regarding the other persons;

another person's ID receiving means for receiving another persons' ID transmitted from one of the terminal devices;

information retrieving means for retrieving information from the user's own information storing means which corresponds to the other person's ID which the another person's ID receiving means receives, and for retrieving information stored in the other persons' information storing means of the user in connection with the other person's ID; and

information transmitting means for transmitting information retrieved by the information retrieving means, to the terminal device that transmitted the other person's ID, through the communication network.

The computer-readable recording medium according to the eleventh aspect of this invention, may further store a program for controlling the computer device to function as user's own information receiving means for receiving information regarding each of the users of the terminal devices, transmitted from each of the terminal devices.

In this case, the user's own information storing means may store information regarding each user which the user's own information receiving means receives, in connection with each user's ID.

In the computer-readable recording medium according to the eleventh aspect of this invention, the information retrieving means may retrieve, in the case where the another person's ID receiving means receives the user's ID as well as the other person's ID, and the received other person's ID is stored in the other persons' information storing means of the user, information from the user's own information storing means and the other persons' information storing means.

The computer-readable recording medium according to the eleventh aspect of this invention, may further store a program for controlling the computer device to function as ID level storing means for storing another person's ID which each user obtains, in connection with an information disclosure level which the other person designates.

In this case:

information regarding the user stored in the user's own information storing means may be added with an information disclosure level; and

the information retrieving means may search the ID level storing means to retrieve information from the user's own information storing means, to the degree of the information disclosure level which corresponds to the received other person's ID.

To achieve the above objects, in the computer-readable recording medium which stores a program, according to the twelfth aspect of this invention, the program controls a computer device which is connected to the server device according to the fifth aspect of this invention, through a communication network, to function as one of the terminal devices which comprise:

another person's ID inputting means for inputting an ID of another person whose information the user wants to obtain;

another person's ID transmitting means for transmitting the other person's ID input from the another person's ID inputting means, to the another person's ID receiving means through the communication network;

information receiving means for receiving information transmitted from the information transmitting means of the server device in response to the transmission of the other person's ID from the another person's ID transmitting means; and

information outputting means for outputting information which the information receiving means receives.

To achieve the above objects, in the computer-readable recording medium which stores a program, according to the thirteenth aspect of this invention, the program controls a computer device which is connected to the server device according to the fifth aspect of this invention, through a communication network, to function as:

another person's ID inputting means for inputting another person's ID which the user obtains; and

another person's ID transmitting means for transmitting the other person's ID input from the another person's ID inputting means, to the business card managing server device through the communication network, and storing the other person's ID in the other persons' information storing means.

To achieve the above objects, in the carrier wave which superimposes a signaled program, according to the fourteenth aspect of this invention, the program controls a computer device which is connected to a plurality of terminal devices, each of which is used by a user for requesting information regarding another person, by transmitting the other person's ID, through a communication network, to function as:

user's own information storing means for storing each user's ID and information regarding each user;

a plurality of other persons' information storing means which are respectively set up for each user and are for storing other persons' IDs which each user obtains, in connection with information regarding the other persons;

another person's ID receiving means for receiving another person's ID transmitted from one of the terminal devices;

information retrieving means for retrieving information from the user's own information storing means which corresponds to the other person's ID which the another person's ID receiving means receives, and for retrieving information stored in the other persons' information storing means of the user in connection with the other person's ID; and

information transmitting means for transmitting information retrieved by the information retrieving means, to the terminal device that transmitted the other person's ID, through the communication network.

In the carrier wave according to the fourteenth aspect of this invention, the program may further control the computer device to function as user's own information receiving means for receiving information regarding each of the users of the terminal devices, transmitted from each of the terminal devices.

In this case, the user's own information storing means may store information regarding each user which the user's own information receiving means receives, in connection with each user's ID.

In the carrier wave according to the fourteenth aspect of this invention, the information retrieving means may retrieve, in the case where the another person's ID receiving means receives the user's ID as well as the other person's ID, and the received other person's ID is stored in the other persons' information storing means of the user, information from the user's own information storing means and the other persons' information storing means.

In the carrier wave according to the fourteenth aspect of this invention, the program may further control the computer device to function as ID level storing means for storing another person's ID which each user obtains, in connection with an information disclosure level which the other person designates.

In this case, information regarding the user stored in the user's own information storing means may be added with an information disclosure level; and

the information retrieving means may search the ID level storing means to retrieve information from the user's own information storing means, to the degree of the information disclosure level which corresponds to the received other person's ID.

To achieve the above objects, in the carrier wave which superimposes a signaled program, according to the fifteenth aspect of this invention, the program controls a computer device which is connected to the server device according to the fifth aspect of this invention, through a communication network, to function as one of the terminal devices which comprise:

another person's ID inputting means for inputting an ID of another person whose information the user wants to obtain;

another person's ID transmitting means for transmitting the other person's ID input from the another person's ID inputting means, to the another person's ID receiving means through the communication network;

information receiving means for receiving information transmitted from the information transmitting means of the server device in response to the transmission of the other person's ID from the another person's ID transmitting means; and

information outputting means for outputting information which the information receiving means receives.

To achieve the above objects, in the carrier wave which superimposes a signaled program, according to the sixteenth aspect of this invention, the program controls a computer device which is connected to the server device according to the fifth aspect of this invention, through a communication network, to function as:

another person's ID inputting means for inputting another person's ID which the user obtains; and

another person's ID transmitting means for transmitting the other person's ID input from the another person's ID inputting means, to the business card managing server device through the communication network, and storing the other person's ID in the other persons' information storing means.

### BRIEF DESCRIPTION OF THE DRAWINGS

These objects and advantages of the present invention will become more apparent upon reading of the following detailed description and the accompanying drawings in which:

FIG. 1 is a block diagram showing the structure of the business card managing system according to one embodiment of the present invention;

FIG. 2 is a block diagram showing the structure of the business card managing server in FIG. 1;

FIG. 3A is a diagram showing the business card ID database contained in the business card information database in FIG. 2;

FIG. 3B is a diagram showing one of the user's own information databases contained in the business card information database in FIG. 2;

FIG. 3C is a diagram showing one of the other persons' information databases contained in the business card information database in FIG. 2;

FIG. 4 is a block diagram showing the structure of the business card managing client in FIG. 1;

FIG. 5A is a diagram showing the operation selection menu displayed on the business card managing client in FIG. 4;

FIGS. 5B and SC are diagrams showing the pop-up windows displayed in connection with the operation selection menu in FIG. 5A;

FIGS. 6A and 6B are diagrams showing the list of the business card IDs displayed on the display device in FIG. 4;

FIGS. 7A and 7B are diagrams showing business card information displayed on the display device in FIG. 4;

FIG. 8 is a block diagram showing the structure of the cellular phone in FIG. 1;

FIGS. 9A to 9C are diagrams showing the business card ID issue-exchange screen displayed on the cellular phone in FIG. 1;

FIG. 10A is a flowchart showing the processes performed by the cellular phone in the business card ID issue-exchange process, FIG. 10B is a flowchart showing the processes performed by the business card managing server in the same process;

FIG. 11A is a flowchart showing the processes performed by the business card managing client in the business card information renewal process, FIG. 11B is a flowchart showing the processes performed by the business card managing server in the same process; and

FIG. 12A is a flowchart showing the processes performed by the business card managing client in the business card information browsing process, FIG. 12B is a flowchart showing the processes performed by the business card managing server in the same process.

### DETAILED DESCRIPTION OF THE PREFERRED EMBODIMENTS

An embodiment of the present invention will now be described below with reference to the attached drawings.

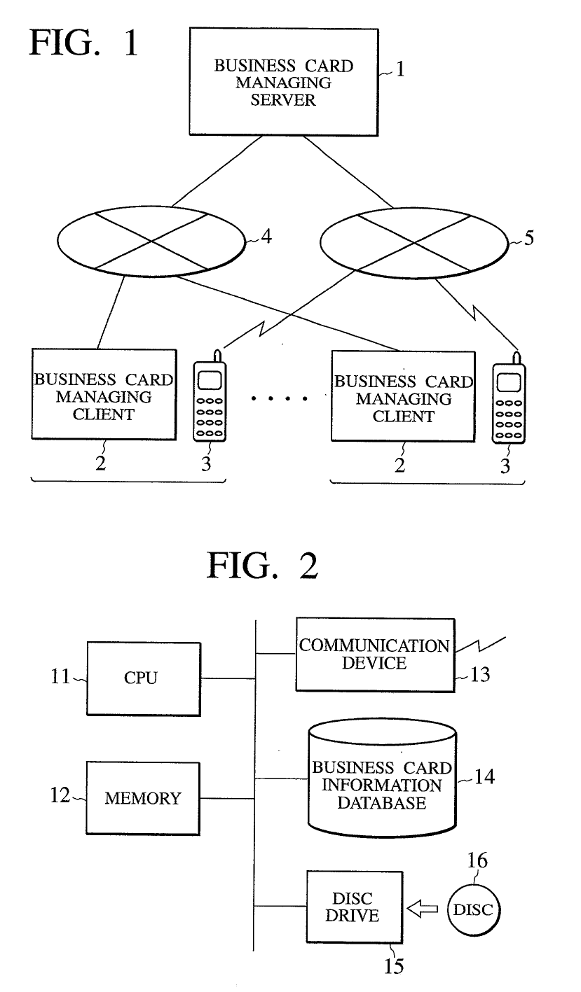

FIG. 1 is a block diagram showing the structure of the business card managing system according to this embodiment. As shown in FIG. 1, this business card managing system comprises a business card managing server 1 for managing business card information, business card managing clients 2 which are respectively connected to the business card managing server 1 through the Internet 4, and are used by users to whom the business card managing service provided by the business card managing server 1 is available, and cellular phones 3 which are respectively connected to the business card managing server 1 through a cellular phone net 5, and are capable of information exchange discussed later with the business card managing server 1. The cellular phones 3 are capable of accessing the Internet 4 through the cellular phone net 5.

In this business card managing system, when persons who have the cellular phone 3 confront each other, they exchange their business card IDs, and register the obtained business card ID in the business card managing server 1 from the cellular phone 3 through the cellular phone net 5. At the time the person who registers this business card ID in the business card managing server 1, can also register additional information, such as the situation when the persons met, in the business card managing server 1 from the cellular phone 3.

A user of the business card managing service can browse business card information managed in the business card managing server 1 by using both of the user's own business card ID and an obtained other person's business card ID, and accessing the business card managing server 1 from the business card managing client 2. The business card information contains information input by the other person besides information input by the user. Therefore, the person who browses the business card information can obtain the latest information input by the other person.

FIG. 2 is a block diagram showing the structure of the business card managing server 1. As shown in FIG. 2, the business card managing server 1 comprises a CPU (Central Processing Unit) 11, a memory 12, a communication device 13, a business card information database 14, and a disc drive 15. A disc 16 which is constituted by a CD-ROM, a DVD and the like, and stores a program shown in a flowchart discussed later is to e inserted into the disc drive 15.

The CPU 11 executes a program which is stored in the memory 12 and shown in a flowchart discussed later. The memory 12 stores the operation program of the CPU 11, and is to be used as a work area for the CPU 11 at the time of executing the program. The communication device 13 processes communications between itself and the business card managing clients 2 through the Internet 4, and between itself and the cellular phones 3 through the cellular phone net 5 according to an instruction given by the CPU 11. The communication device 13 is always on standby for reception of information sent from the business card managing clients 2 and the cellular phones 3.

The disc drive 15 reads out the program stored in the disc 16 and transfers the program to store in the program area of the memory 12. Though, the same program as above may be stored in a fixed disc device included in a Web server device on the Internet 4. The communication device 13 may receive the program which is superimposed in a carrier wave and sent from the Web server device through the Internet 4, and transfer the program to store in the program area of the memory 12.

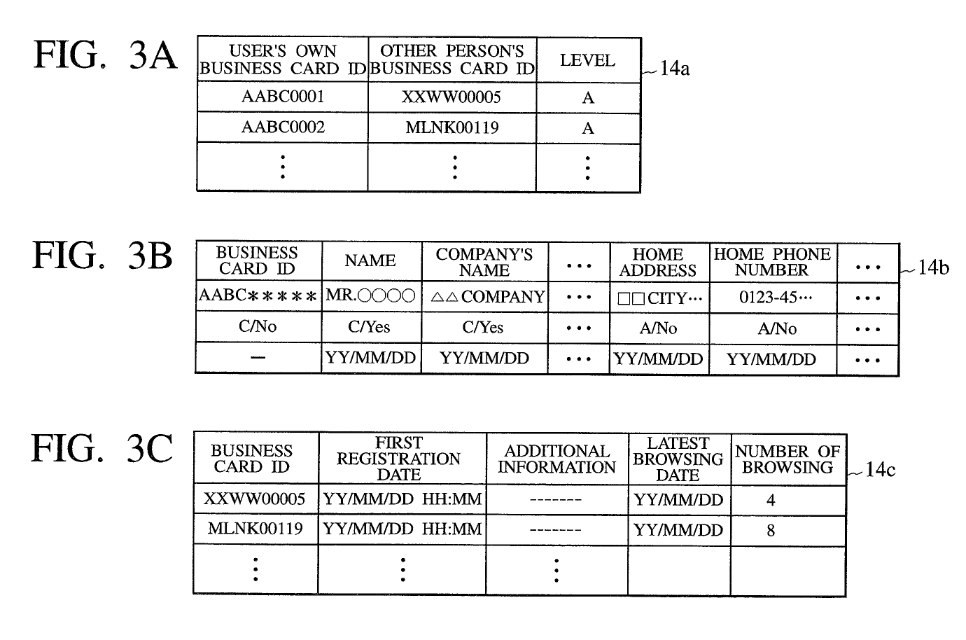

The business card information database 14 is a database for storing information necessary for providing business card information. The business card information database 14 comprises a business card ID database 14a shown in FIG. 3A, a plurality of user's own information databases 14b shown in FIG. 3B, and a plurality of other persons' information databases 14c shown in FIG. 3C.

The business card ID database 14a stores records of a user's own business card ID, another person's business card ID which is obtained in exchange for the user's own business card ID, and a level designated when the user's own business card ID was issued all in connection. A business card ID is composed of, for example, three alphabetical characters at the front set specific to each user, and five numerals at the end set specific to each of other persons. The level is for designating to what extent a user who gives business card ID to another person provides the user's own business card information to him/her.

The user's own information database 14b is set up for each user, and is for registering personal information such as the business card ID, his/her name, his/her company's name, . . . , his/her home address, his/her home phone number, . . . , and the like. Information in each of the sections on the third line in FIG. 3B shows a level of the person to whom information is to be provided (level designation) and a flag showing whether or not it is possible to provide information when a user's agent accesses the database (agent permission flag). And information in each of the sections on the fourth line in FIG. 3B indicates the date on which the content of each item was renewed most lately. Information which has the same contents as those of the user's own information database 14b is retained also in the business card managing client 2. Items to be registered in the user's own information database 14b may be customized by each user.

The other persons' information database 14c is set up for each user, and is for registering business card IDs of other persons with whom each user has exchanged business card IDs, the first registration dates, additional information, the latest browsing dates, and the numbers of browsing. The first registration date and additional information are to be registered in the other persons' information database 14c when business card IDs are exchanged.

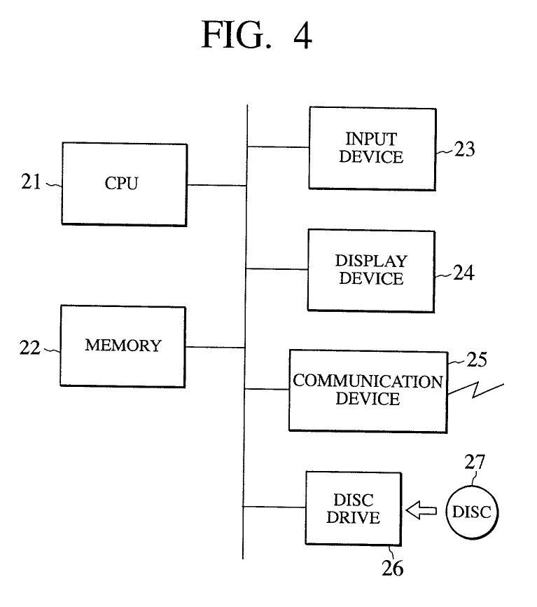

FIG. 4 is a block diagram showing the structure of the business card managing client 2 shown in FIG. 1. As shown in FIG. 4, the business card managing client 2 comprises a CPU 21, a memory 22, an input device 23, a display device 24, a communication device 25, and a disc drive 26. A disc 27 which stores a program shown in a flowchart discussed later is to be inserted into the disc drive 26.

The CPU 21 executes a program which is stored in the memory 22 and shown in a flowchart discussed later. The memory 22 stores the operation program of the CPU 21, and is to be used as a work area for the CPU 21 at the time of executing the program. The input device 23 comprises a mouse, a keyboard and the like, and is for selecting items on a menu screen discussed later and for inputting business card IDs and other information. The communication device 25 processes communications between itself and the business card managing server 1 through the Internet 4 according to an instruction given by the CPU 21.

The disc drive 26 reads out the program stored in the disc 27 and transfers the program to store in the program area of the memory 22. Though the same program as this may be stored in a fixed disc device included in a Web server device on the Internet 4. The communication device 25 may receive the program superimposed in a carrier wave and sent from the Web server device through the Internet 4, and transfer the program to store in the program area of the memory 22.

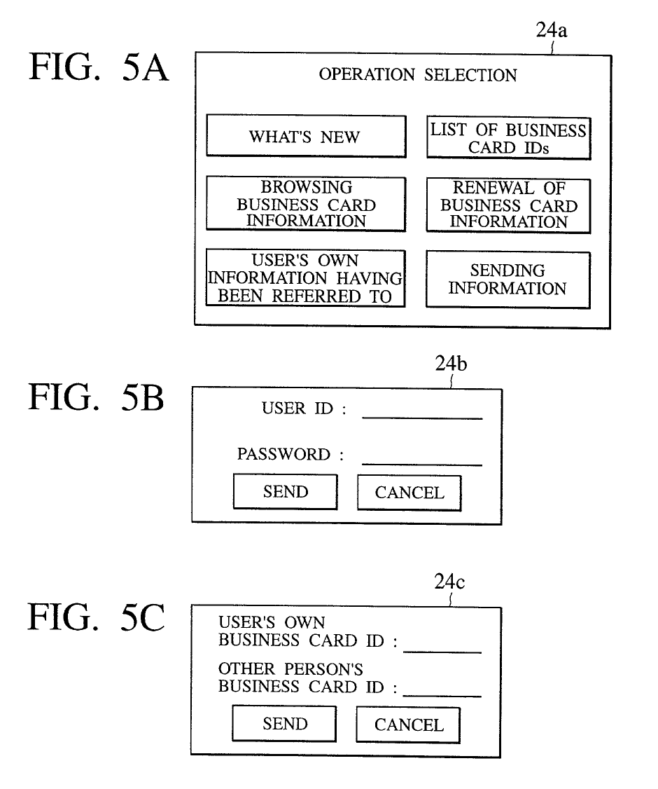

The display device 24 displays information input from the input device 23 or information corresponding to information which the communication device 25 receives from the business card managing server 1. When the program of the business card managing client 2 is started, the display device 24 displays, for example, an operation selection menu 24a shown in FIG. 5A for the beginning.

The operation selection menu 24a is a menu in which a user or an agent of the user, such as a secretary can select a desired operation item from items, “What's New”, “The List of the Business Card IDs”, “Browsing the Business Card Information”, “Renewal of the Business Card Information”, “User's Own Information Having Been Referred To”, and “Sending Information”.

“What's New” is an item for browsing other person's renewed business card information which a user or an agent has not browsed yet. Contents to be displayed according to “What's New” are different depending on which of the user and the agent accesses. “The List of the Business Card IDs” is an item for browsing a list of other persons' business card IDs which a user has obtained. List of business card IDs to be displayed according to this item are different depending on which of the user and the agent accesses.

“Browsing the Business Card Information” is an item for browsing business card information of other persons with whom the user has exchanged the business card IDs. Contents to be displayed by selecting this item contain both of the data registered in the other persons' information database 14c of the user and the data registered in the user's own information database 14b of the other person. Business card information to be displayed according to this item is different depending on which of the user and the agent accesses.

“Renewal of the Business Card Information” is an item for renewing personal information of a user registered in the user's own information database 14b. Contents to be displayed by selecting this item are not different depending on which of the user and the agent accesses. The user or the agent inputs desired information from the input device 23 according to the displayed contents.

“User's Own Information Having Been Referred To” is an item for browsing by whom and how many times business card information of a user has been referred to, and when is the last time of reference. Contents to be displayed by selecting this item are not different depending on which of the user and the agent accesses. “Sending Information” is an item for sending necessary information to a cellular phone 3 of the user from his/her agent, by sending a mail through the business card managing server 1.

When one of the items “What's New”, “The List of the Business Card IDs”, or “Browsing the Business Card Information” is selected on the operation selection menu 24a, the display device 24 displays a pop-up window 24b shown in FIG. 5B. When the item “Browsing the Business Card Information” is selected, the display device 24 further displays a pop-up window 24c shown in FIG. 5C.

A section for inputting a user ID and a section for inputting a password are provided in the pop-up window 24b. A user or an agent inputs his/her user ID and password according to the pop-up window 24b and sends the input user ID and password to the business card managing server 1. And then contents of the selected item is sent from the business card managing server 1 to the business card managing client 2. A user ID and password are provided to each of the user and the agent respectively. Contents of information to be provided to the business card managing client 2 from the business card managing server 1 are different depending on whose user ID and password are used.

A section for inputting a user's own business card ID and a section for inputting another person's business card ID are provided in the pop-up window 24c. By inputting and sending both business card IDs to the business card managing server 1, the user obtains business card information corresponding to the other person's business card ID. A wild card may be used at the time of inputting a user's own business card ID.

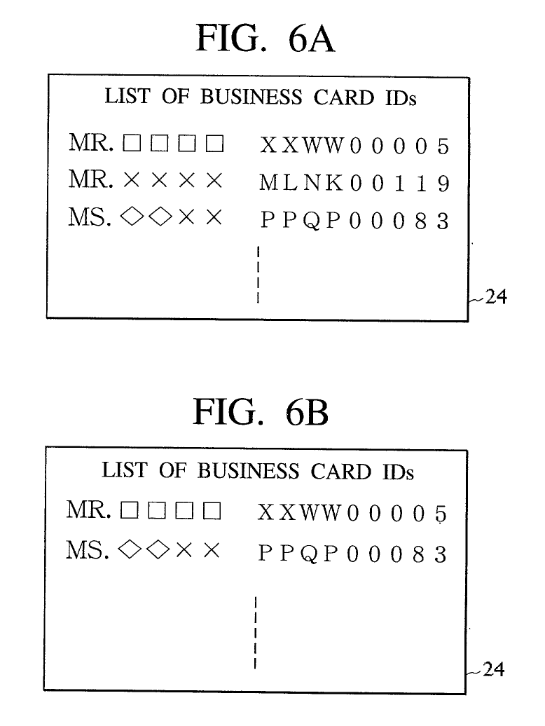

FIGS. 6A and 6B are diagrams showing the list of the business card IDs displayed on the display device 24 by selecting the item “The List of the Business Card IDs”. FIG. 6A is a diagram of the list displayed in the case where the operation is made by a user, and FIG. 6B is a diagram of the list displayed in the case where the operation is made by an agent.

As shown in FIG. 6A, in the case where a user operates, business card IDs XXWW00005, MLNK00119, PPQP00083, . . . are displayed. On the other hand, as shown in FIG. 6B, in the case where an agent operates, business card IDs XXWW00005, PPQP00083, . . . , are displayed but the business card ID MLNK00119 is not displayed. This is because Mr.xxxx having the business card ID MLNK***** has set “No” in the section of the agent permission flag in his user's own information database 14b.

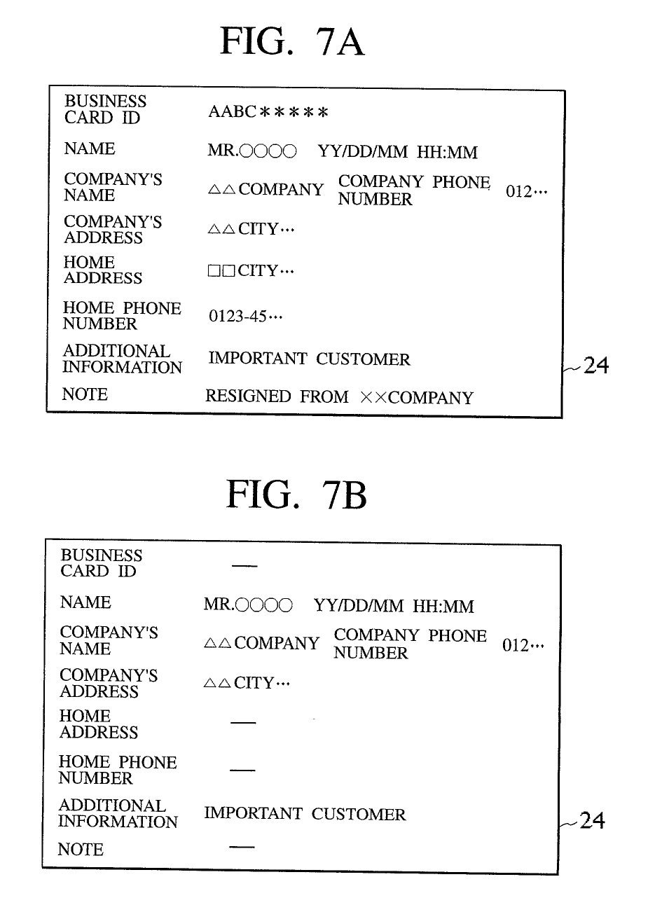

FIGS. 7A and 7B are diagrams showing other person's business card information displayed on the display device 24 by selecting the item “Browsing the Business Card Information”. FIG. 7A is a diagram of the display in the case where the operation is made by a user, and FIG. 7B is a diagram of the display in the case where the operation is made by an agent. In this case, the level designations which the person whose information is referred to is all “A”.

As shown in FIG. 7A, in the case where the user operates, all information of items whose level designation is A is to be displayed. On the other hand, as shown in FIG. 7B, in the case where the agent operates, information of items whose agent permission flag is designated “No” is not to be displayed even if the level designation of the items is A.

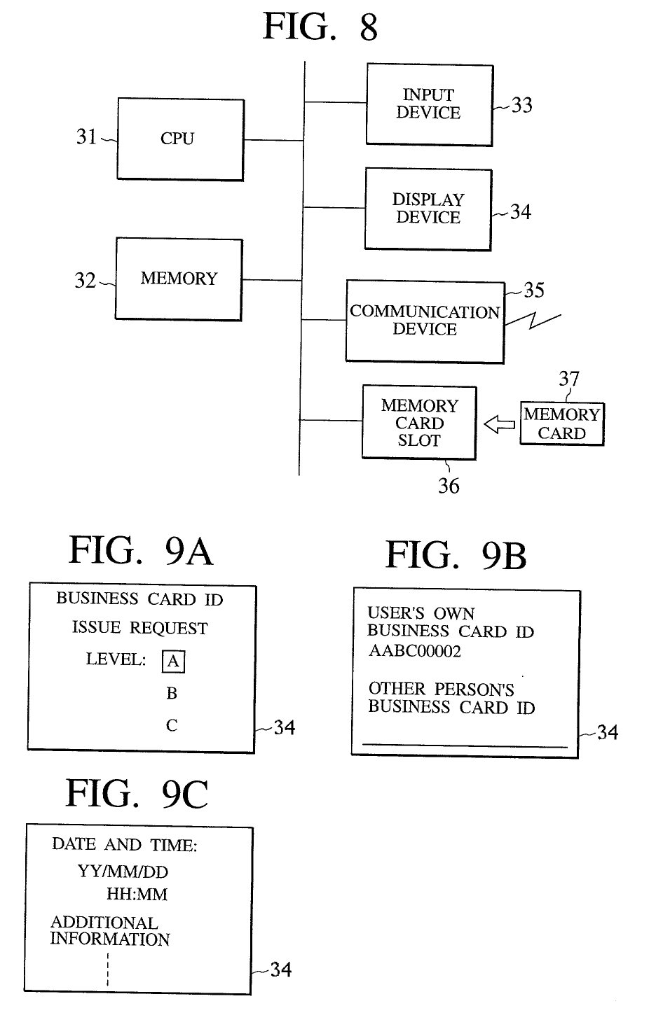

FIG. 8 is a block diagram showing the structure of the cellular phone 3 shown in FIG. 1, especially, the structure of the section relating to information exchange with the business card managing server 1. As shown in FIG. 8, the cellular phone 3 has function of a kind of a computer device and comprises a CPU 31, a memory 32, an input device 33, 110 a display device 34, a communication device 35, and a memory card slot 36. The cellular phone 3 also has components necessary for a telephone call. However, those components have nothing to do with the present invention, so the explanation will be omitted.

The CPU 31 executes a program which is stored in the memory 32 and shown in a flowchart discussed later. The memory 32 stores the operation program of the CPU 31 and is used as a work area for the CPU 31 at the time of executing the program. The input device 33 comprises number keys used for inputting phone numbers, and is for inputting other persons' business card IDs and other information. The communication device 35 has a function for exchanging information with the base station, to process the communications between itself and the business card managing server 1 through the cellular phone net 5 according to an instruction given by the CPU 31.

A memory card 37, which is composed of a semiconductor memory and the like, is to be inserted into the memory card slot 36. The memory card 37 stores a program shown in a flowchart discussed later. The CPU 31 transfers the program stored in the memory card 37 to the memory 32 and executes the program in the memory 32. This program may be stored in a fixed disc device included in a Web server device on the Internet 4. The communication device 35 may receive the program which is superimposed in a carrier wave and sent from the Web server device through the Internet 4 and the cellular phone net 5, and transfer the program to store in the program area of the memory 32.

The display device 34 is composed of an LCD (Liquid Crystal Display) panel and the like, and displays a menu screen for performing a series of processes from issuing a business card ID, exchanging IDs to registering the obtained ID in the business card managing server 1 (hereinafter, this menu screen will be referred to as “business card ID issue-exchange screen”), besides displaying character information such as callers' phone number, registered other persons' phone number, and a mail to be sent and a mail received.

FIGS. 9A to 9C are diagrams showing the business card ID issue-exchange screen. When a user performs a predetermined operation from the input device 33, the display device 34 displays the first page of the business card ID issue-exchange screen shown in FIG. 9A. On this first page, a user selects the level which is to be designated in correspondence with a business card ID to be issued. When the user selects the level and operates the sending key of the input device 33, an issue request of a business card ID and the selected level are sent from the communication device 35 to the business card managing server 1.

The display device 34 displays the second page of the business card ID issue-exchange screen shown in FIG. 9B, when the communication device 35 receives the business card ID from the business card managing server 1 in response to the issue request of the business card ID. On this second page, a section for representing the received user's own business card ID and a section for inputting the other person's business card ID to be obtained are provided.

When the user inputs the other person's business card ID and operates the setting key of the input device 33, the display device 34 displays the third page of the business card ID issue-exchange screen shown in FIG. 9C. On this third page, a section for representing the present date and time and a section for inputting additional information regarding the other person are provided. Additional information may not only be such that a user input desired characters from the input device 33, but also be input by selecting a predetermined item from a menu which is previously registered. By the user operating the sending key while this third page is displayed, the business card ID and additional information are sent from the communication device 35 to the business card managing server 1.

Operations of the business card managing system according to this embodiment will now be described below. There are operations of:

(1) issue and exchange of the business card ID;

(2) renewal of the user's own business card information;

(3) browsing of the other person's business card information; and

(4) other operations,

as the operations of the business card managing system.

(1) Issue and Exchange of the Business Card ID

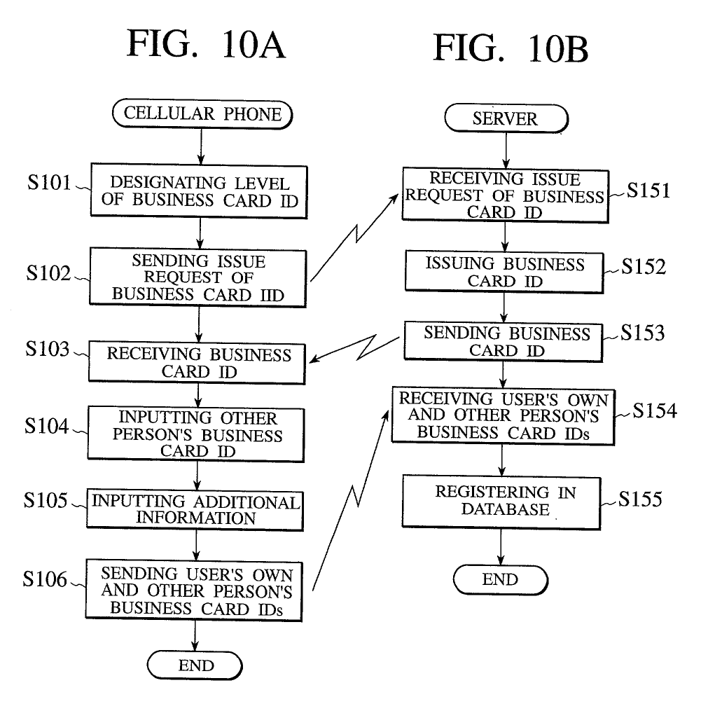

Issue and exchange of the business card ID are performed by accessing the business card managing server 1 from the cellular phone 3. FIGS. 10A and 10B are flowcharts of the business card ID issue-exchange process respectively performed by the cellular phone 3 and the business card managing server 1.

First, a user of the cellular phone 3 operates the input device 33 to display the first page of the business card ID issue-exchange screen on the display device 34. By operating the input device 33 while this screen is displayed, the user designates the level for specifying information to be provided to the other person whom the user confront (step S101).

By the user operating the sending key of the input device 33, the CPU 31 controls the communication device 35 to send an issue request of a business card ID and the designated level to the business card managing server 1 through the cellular phone net 5 (step S102). The communication device 13 of the business card managing server 1 receives the issue request of a business card ID and the level designated by the user (step S151).

The CPU 11 of the business card managing server 1 issues a business card ID in response to the reception of the issue request. More specifically, the CPU 11 examines the business card ID database 14a and issues an unused business card ID of the above user's own, and registers the issued business card ID and the level received together with the issue request both in connection in the business card ID database 14a (step S152).

The CPU 11 gives the issued business card ID to the communication device 13. The communication device 13 sends the issued ID to the cellular phone 3 of the user through the cellular phone net 5 (step S153). The communication device 35 of the cellular phone 3 receives the issued business card ID as the user's own business card ID. In response to the reception of the business card ID, the CPU 31 controls the display device 34 to display the second page of the business card ID issue-exchange screen on the display device 34 (step S103). The other person whom the user confronts also obtains the user's own business card ID of the other person's own in the same manner.

The user of the cellular phone 3 exchanges the business card IDs with the person whom the user confronts, and inputs the obtained business card ID as the other person's business card ID from the input device 33, according to the second page of the business card ID issue-exchange screen displayed on the display device 34 (step S104). Next, when the user operates the setting key of the input device 33, the screen on the display device 34 is switched to the third page of the business card ID issue-exchange screen. Then, if necessary, the user inputs additional information such as the importance degree of customer and the place where they confront, from the input device 33 (step S105).

When the user operates the sending key of the input device 33, the communication device 35 sends the user's own business card ID, the other person's business card ID, the input additional information, and the current time which an inner timer (not shown) keeps, to the business card managing server 1 through the cellular phone net 5 (step S106). Now, the processes of the cellular phone 3 have been finished. The communication device 13 of the business card managing server 1 receives the user's own business card ID, the other person's business card ID, the additional information, and the current time sent from the cellular phone 3 (step S154).

The CPU 11 extracts the other person's business card ID from the received information, and registers this in the business card ID database 14a in connection with the user's own business card ID. Further, the CPU 11 extracts the other person's business card ID, the additional information, and the current time from the received information, and registers them in the other persons' information database 14c which corresponds to the received user's own business card ID (step S155). Now, the processes for issue-exchange of the business card ID have all ended.

(2) Renewal of the User's Own Business Card Information

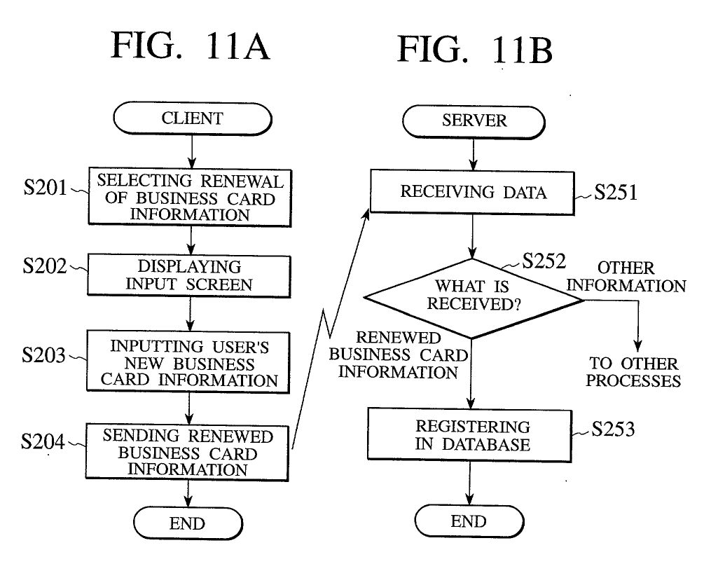

Renewal of the user's own business card information is performed by accessing the business card managing server 1 from the business card managing client 2. FIGS. 11A and 11B are flowcharts of the business card information renewal process respectively performed by the business card managing client 2 and the business card managing server 1.

A user or an agent operates the input device 23 to select the item “Renewal of the Business Card Information” while the operation selection menu 24a is displayed on the display device 24 of the business card managing client 2 (step S201). When the item “Renewal of the Business Card Information” is selected, the CPU 21 controls the display device 24 to display a predetermined input screen based on the information which is the same as the information stored in the user's own information database 14b (step S202).

The user of the business card managing client 2 inputs the user's new business card information of each item from the input device 23 according to the input screen displayed on the display device 24. At this time, change of the level designation or agent permission flag indicated on the third line in FIG. 3B can also be performed (step S203). In this case, new business card information of the user can also be input.

The communication device 25 sends the input new business card information to the business card managing server 1 through the Internet 4 according to an instruction given by the CPU 21 (step 204). Now, the processes of the business card managing client 2 have been finished. Then, the communication device 13 of the business card managing server 1 which is on standby for reception, receives the business card information sent from the business card managing client 2 (step S251). Then the CPU 11 judges what kind of information the received information is (step S252).

If it is judged that the received information is new business card information which has been renewed, the process goes on to the next step S253. On the other hand, if it is not judged that the received information is renewed new business card information, the business card managing server 1 performs other processes. Those other processes have nothing to do with the “Renewal of the User's Own Business Card Information”, so the explanation will be omitted.

In step S253, the CPU 11 of the business card managing server 1 registers the new business card information which the communication device 13 receives, in the user's own information database 14b which corresponds to the user. At this time, in regard to the items whose contents have been changed in the sections on the second line in FIG. 3B, the latest renewal dates indicated in the sections on the fourth line are rewritten to the current time kept by an inner timer (not shown). Now, processes for renewal of the user's own business card information have been finished.

(3) Browsing of the Other Person's Business Card Information

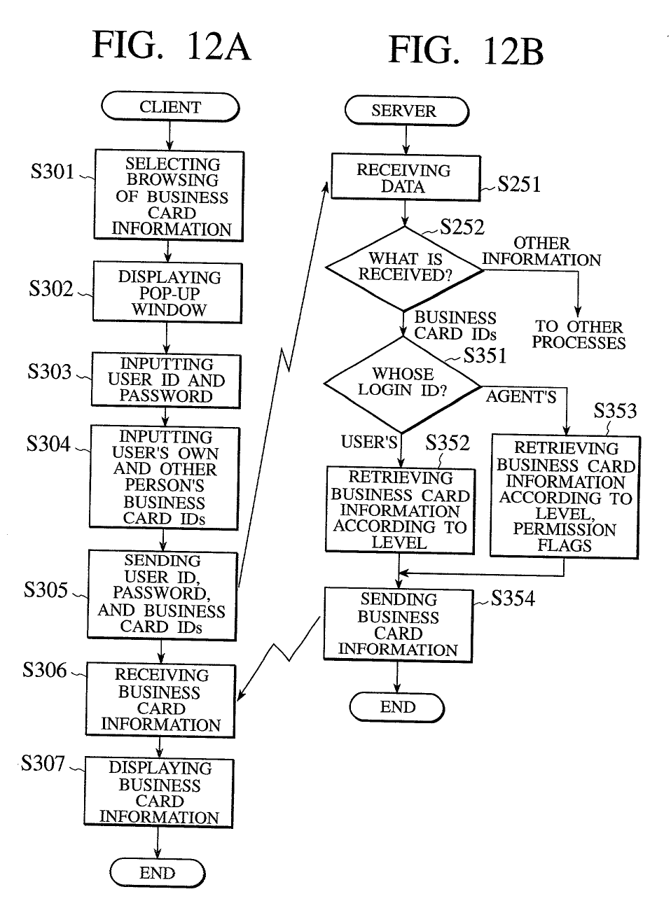

Browsing of the other person's business card information is performed by accessing the business card managing server 1 from the business card managing client 2. FIGS. 12A and 12B are flowcharts of the business card information browsing process respectively performed by the business card managing client 2 and the business card managing server 1.

A user or an agent operates the input device 23 to select the item “Browsing the Business Card Information” while the operation selection menu 24a is displayed on the display device 24 of the business card managing client 2 (step S301). When the item “Browsing the Business Card Information” is selected, the CPU 21 controls the display device 24 to display the pop-up windows 24b and 24c (step S302).

The user or the agent inputs the user ID and password of the user or the agent by operating the input device 23 according to the pop-up window 24b (step S303). Further, the user or the agent inputs the user's own business card ID and the business card ID of another person whose business card information the user wants to browse, by operating the input device 23 according to the pop-up window 24c (step S304).

The communication device 25 sends the input user ID, password, the user's own and the other person's business card IDs to the business card managing server 1 through the Internet 4 according to an instruction given by the CPU 21 (step S305). The communication device 13 of the business card managing server 1 which is on standby for reception, receives the information sent from the business card managing client 2 (step S251). Then the CPU 11 judges what kind of information the received information is (step S252).

If it is judged that the received information is user's own and the other person's business card IDs, the process goes on to the next step S351. On the other hand, if it is not judged that the received information is user's own and the other person's business card IDs, the business card managing server 1 performs other processes. Those other processes have nothing to do with “Browsing of the Other Person's Business Card Information”, so the explanation will be omitted. In step S351, the CPU 11 judges whether the received user ID and password, that is, the user ID and password logged in are the user's or the agent's.

If it is judged that the user ID and password are the user's, the CPU 11 retrieves the information which is stored in the other persons' information database 14c of the user in connection with the received other person's ID. The CPU 11 searches the business card ID database 14a by using the other person's business card ID and user's own business card ID in this order as a search key, and obtains the correspondent designated level. The CPU 11 retrieves the information registered in the user's own information database 14b which corresponds to the other person's business card ID, according to the obtained level (step S352). Then, the process goes on to the step S354.

On the other hand, if it is judged that the user ID and password are the agent's, the CPU 11 retrieves the information which is stored in the other persons' information database 14c of the user in connection with the received other person's ID. And the CPU 11 searches the business card ID database 14a by using the other person's business card ID and user's own business card ID in this order as a search key, and obtains the correspondent designated level. The CPU 11 retrieves the information registered in the user's own information database 14b which corresponds to the other person's business card ID, according to the obtained level, regarding only to the items whose agent permission flag is set “Yes” (step S353). Then, the process goes on to the step S354.

In step S354, the CPU 11 generates business card information of the predetermined format based on the information that was retrieved in step S352 or S353. The communication device 13 sends the business card information generated by the CPU 11 to the business card managing client 2 through the Internet 4. The processes of the business card managing server 1 have been finished.

The communication device 25 of the business card managing client 2 receives the business card information sent from the business card managing server 1 (step S306). Then, the CPU 21 controls the display device 24 to display the received business card information for browsing of the user or the agent (step S307). Now, the processes for browsing the other person's business card information have been finished.

(4) Other Operations

In the case where a user or an agent of the business card managing client 2 selects the item “What's New” and the communication device 13 of the business card managing server 1 receives the corresponded information, the CPU 11 searches the other persons' information database 14c of the user and acquires the dates on which the user or the agent browsed the business card information of each of other persons most lately. Then, the CPU 11 compares the acquired dates with the latest renewal dates of each of the items in the user's own information database 14b of the other persons.

In the case where there are items whose latest renewal dates are newer than the latest browsing dates, the CPU 11 acquires the information of items whose level designation or agent permission flag show that the information can be browsed by the user or the agent, as new data, together with the other persons' business card IDs and names. The CPU 11 controls the communication device 13 to send the acquired information to the business card managing client 2 through the Internet 4. In the business card managing client 2, when the communication device 25 receives the information, the information is displayed on the display device 24 to be browsed by the user or the agent.

In the case where a user or an agent of the business card managing client 2 selects the item “The List of the Business Card IDs” and the communication device 13 of the business card managing server 1 receives the corresponded information, the CPU 11 acquires one or more other persons' business card IDs and names which are stored in the business card ID database 14a in connection with the business card IDs of the user. And when the agent operates, the CPU 11 further searches one or more user's own information databases 14b which correspond to the business card IDs of each of the other persons, and removes the business card IDs and names whose agent permission flags are set “No”.

The CPU 11 controls the communication device 13 to send the remainders among the acquired business card IDs and names which were not removed, to the business card managing client 2 through the Internet 4 in a list format. In the business card managing server 2, when the communication device 25 receives the list of the business card IDs, the list is displayed on the display device 24 to be browsed by the user or the agent.

In the case where a user or an agent of the business card managing client 2 selects the item “User's Own Information Having Been Referred To” and the communication device 13 of the business card managing server 1 receives the corresponded information, the CPU 11 searches the other persons' information databases 14c of all of the other persons, and checks whether the user's business card ID is registered or not. If the user's business card ID is registered, the CPU 11 acquires, as the logs of the user's own information having been referred to, the latest browsing dates and the numbers of browsing which are registered in the other persons' information databases 14c in connection with the user's business card ID, together with the other persons' business card IDs and/or names.

The CPU 11 sorts acquired logs of the user's own information having been referred to in order from the newest latest browsing date, or in order from the largest number of browsing, and makes a list of the logs. The CPU 11 controls the communication device 13 to send the list to the business card managing client 2 through the Internet 4. In the business card managing client 2, when the communication device 25 receives the list, the list is displayed on the display device 24 to be browsed by the user or the agent.

In the case where an agent of a user of the business card managing client 2 selects the item “Sending Information”, a menu for further selecting one of the items “What's New”, “Browsing the Business Card Information”, and “User's Own Information Having Been Referred To” is displayed on the display device 24 in the business card managing client 2. By the agent performing the same processes as mentioned above, information sent from the business card managing server 1 is displayed on the display device 24 of the business card managing client 2.

The agent designates the range of information to be sent, out of the displayed information, and instructs on the transmission of the designated range of information by operating the input device 23. The CPU 21 sends the designated range of information and a transmission request to the business card managing server 1 through the Internet 4 in response to the instruction.

When the communication device 13 in the business card managing server 1 receives the transmission request, the CPU 11 extracts the information sent together with the transmission request and sends the extracted information to the cellular phone 3 of the user through the cellular phone net 5. And when the communication device 35 of the cellular phone 3 of the user receives the information, the information is displayed on the display device 34 to be browsed by the user.

As described above, in the business card managing system according to this embodiment, before browsing other person's business card information, a user needs only to exchange business card IDs and send the obtained business card ID from the cellular phone 3 to the business card managing server 1. Due to this, there is no need for a user of the business card managing client 2 and the cellular phone 3 to take time to input other person's information. If there is a change in another person's condition, there is no need for each user (or agent) to input the change.

When the user sends his/her own business card ID and obtained other person's business card ID from the cellular phone 3 to the business card managing server 1, the user can also send additional information from the cellular phone 3 to the business card managing server 1. That is, the user can input additional information regarding the other person whom the user confronts, at the time when the user is confronting the other person. Accordingly, the user can register the situation when the user confronts the other person precisely in the other persons' information database 14c in the business card managing server 1.

The business card information database 14 in the business card managing server 1 contains the plurality of user's own information databases 14b in which each of users (or agents) can register information of the users' own. Due to this, if a user whose condition has changed registers the change in the user's own information database 14b by selecting the item “Renewal of the Business Card Information”, other users can obtain the above user's latest information. And if there is a change in the condition of another person with whom a user has exchanged the business card IDs, the user (or agent) can be informed of the change by selecting the item “What's New”. As described above, each user (or agent) can obtain the latest information regarding another person which follows changes in the condition.

When a user or an agent browses business card information of another person, the user or the agent needs to input the user's own business card ID and the other person's business card ID both corresponding to the above two persons, who have exchanged the IDs. Accordingly, it is difficult for a third party to obtain personal information registered in the user' own information database 14b. Therefore, security on personal information is ensured.

Further, by designating the levels and the agent permission flags, each user has control on which of the other persons can browse the user's own personal information to what extent. Due to this, it is possible to prevent a third party's improper use of the user's own information. Therefore, security on personal information is ensured.

If an agent selects the item “Sending Information” in the business card managing client 2, the business card managing server 1 may send information selected from the information registered in the business card managing server 1, to the cellular phone 3 of the user. Due to this, for example, it is possible for a secretary as an agent to inform a user of, information regarding a person whom the user is meeting or will meet, from the business card managing client 2.

Further, when a user or an agent browses business card information of another person, the total number of browsing and the latest browsing date are to be registered in the other persons' information database 14c of the user. And when the user or the agent selects the item “User's Own Information Having Been Referred To” on the operation selection menu 24a, the business card managing server 1 searches the other persons' information databases 14c of the other persons, and acquires the latest browsing dates and the total numbers of browsing both corresponding to the user's own business card ID, together with the other persons' business card IDs (and names) to send those to the business card managing client 2. Since each user (or agent) is informed of by whom, hen, and how many times the user's own information was browsed, each user can get a clue to know the importance degree of himself/herself to the other persons.

By using the business card managing system according to this embodiment, persons ho meet each other in the business scene, exchange the business card IDs. They exchange no more personal information other than business card IDs. This consequently means that they also exchange business cards that are printed on a paper to disclose their names, and the company, division, or the like they belong to. Accordingly, the business card managing system according to this embodiment can realize simplicity of managing business card information while following the conventional business process.

In the above-described embodiment, each user of the cellular phone 3 inputs another person's business card ID by hand. However, the other person's business card ID may not be input by the user, but may be sent directly from the business card managing server 1. For example, by using the short mail function which cellular phones 3 have, the user may obtain not only the user's own business card ID, but also the other person's business card ID from the business card managing server 1. The cellular phone 3 may send the cellular phone number of another person with whom the user is to exchange business card IDs, to the business card managing server 1 when requesting the issue of the user's own business card ID. The business card managing server 1 may send the issued user's own business card ID to both of the cellular phones 3.

In the above-described embodiment, a new business card ID is issued every time each user exchanges IDs with another person. However, each user may prepare a plurality of business card IDs which respectively correspond to one of the levels, and give one of the business card IDs depending on the person. In this case, the business card ID database 14a may be set up for each user just as the user's own information database 14b and the like, and another person's business card ID and the level may be registered in connection. The other persons' information database 14c may serve also as the business card ID database 14a. In this case, if the cellular phone 3 communicates with another cellular phone 3 directly, the business card IDs of two persons may be exchanged by using this direct communication function.

In the above-described embodiment, a user sends another person's ID to the business card managing server 1 from the cellular phone 3 through the cellular phone net 5 to register in the business card ID database 14a every time the user obtains another person's ID. On the other hand, for example, a user may store business card IDs of plurality of other persons in a memory card to be attached to the cellular phone 3. And then the business card managing client 2 may read out the other persons' business card IDs stored in this memory card and send the read out IDs to the business card managing server 1 through the Internet 4 to register in the business card ID database 14a. Due to this, a user may not register the business card ID every time the user obtains the ID, but can store business card IDs obtained from a plurality of other persons whom the user met in a predetermined period of time in the memory card, and register all the stored IDs simultaneously in the business card ID database 14a.

The business card managing client 2 may send the business card IDs stored in the memory card to the business card managing server 1. And then the business card managing server 1 may extract information of each of the other persons which is in connection with each of the business card IDs, from each of the user's own information databases 14b and the other persons' information database 14c and send the extracted information to the business card managing client 2. Due to this, each user can easily browse personal information of other persons whom the user met and exchanged business card IDs. The memory card may be either one that is detachable from the cellular phone 3 or one that is undetachable from the cellular phone 3. The business card managing client 2 may comprise an appropriate reader device depending on whether the memory card is detachable one or undetachable one.

In the above-described embodiment, additional information to be registered in the other persons' information database 14c is sent to the business card managing server 1 from the cellular phone 3 at the same time as another person's business card ID. However, even after the transmission of the business card ID, additional information may be registered or updated by accessing the business card managing server 1 from the business card managing client 2.

In the above-described embodiment, at the time of browsing business card information of another person, a user or an agent selects the item “Browsing the Business Card Information” on the operation selection menu 24a, and then inputs the user's own business card ID and the other person's business card ID in the pop-up window 24c displayed after the selection of the item. On the other hand, a user or an agent may select a desired business card ID from the list of the business card IDs. In accordance with this selection, the business card information corresponding to this business card ID may be displayed on the display device 24.

In the above-described embodiment, in the case where the information registered in a user's own information database 14b is updated, a user, who has obtained the business card ID whose business card information is updated, can browse the updated information by selecting the item “What's New” on the operation selection menu 24a. On the other hand, in the case where the information registered in a user's own information database 14b of a user is updated, the business card managing server 1 may search all of the other persons' information databases 14c to find other persons who have obtained the business card IDs of the user. And the business card managing server 1 may inform the other person of the updated information by e-mail and the like.

In the above-described embodiment, if a user exchanges business card IDs with another person, only the obtained business card ID is registered in the business card information database 14. On the other hand, the business card managing server 1 may inform the user's business card managing client 2 of the new registration by e-mail and the like at the same time when the obtained business card ID is registered in the business card information database 14. Due to this, for example, the agent of the above user can send the information of the other person whom the user is meeting, from the business card managing client 2 to the cellular phone 3 of the user through the business card managing server 1 by using the function “Sending Information”.

In the above-described embodiment, a user uses the cellular phone 3 to access the business card managing server 1 for issue of an business card ID and registration of an obtained business card ID. However, the business card managing server 1 may be accessed from any terminal devices that have the functions shown in the FIG. 8, such as PDA, wristwatch, and the like. And in the case where portable personal computers and cellular phones which have an Internet access function are used as the terminal devices for issue of an ID and registration of an obtained ID, those portable personal computers and cellular phones may be physically the same as the business card managing client 2.

For example, in the case where the cellular phones have the Internet access function, another person's business card ID obtained by the above-described function of the cellular phone 3 is sent to the business card managing server 1 to be registered in the business card ID database 14a. At any time after the registration, a user can send the other person's business card ID from the business card managing client 2 to the business card managing server 1 to download the other person's business card information from the business card managing server 1.

In the above-described embodiment, business card information is provided from the business card managing server 1 to the business card managing client 2 through the Internet 4, which is an open computer network. However, such a business card information providing service may be provided through, for example, a commercial network, which is a closed computer network. Business card information of members who belong to a company may be provided through the company's LAN.

In the case where the cellular phone 3 has a receiving function of the character information and other contents, the cellular phone 3 may serve also as the business card managing client 2, and the business card information providing service may be provided through the cellular phone net 5. In this case, a communication service provider may set up and control the business card managing server 1 and provide the business card information providing service as an additional service of cellular phones.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2000-56411 filed on Mar. 1, 2000 and including specification, claims, drawings and summary. The disclosure of the above Japanese Patent Application is incorporated herein by reference in its entirety.

What is claimed is:

1. A business card managing system which comprises a server device, and a plurality of first terminal devices and second terminal devices both of which are connected to said server device through a communication network, and at least one of each of which each user uses, wherein:
said server device comprises:
user's own information storing means for storing an ID of each user and information regarding the user;
first another person's ID receiving means for receiving another persons' ID transmitted from one of said first terminal devices;
a plurality of other persons' information storing means which are respectively set up for each user and are for storing other persons' IDs which said first another person's ID receiving means receives, in connection with information regarding the other persons;
second another person's ID receiving means for receiving another persons' ID transmitted from one of said second terminal devices;
information retrieving means for retrieving information from said user's own information storing means which corresponds to another person's ID which said second another person's ID receiving means receives, and for retrieving information stored in said other persons' information storing means of the user in connection with the other person's ID; and
information transmitting means for transmitting information retrieved by said information retrieving means, to one of said second terminal devices that transmitted the other person's ID, through said communication network,
each of the plurality of said first terminal devices comprises:
first another person's ID inputting means for inputting another person's ID which each user obtains; and
first another person's ID transmitting means for transmitting another person's ID input from said first another person's ID inputting means, to said first another person's ID receiving means through said communication network,
each of the plurality of said second terminal devices comprises:
second another person's ID inputting means for inputting another person's ID which corresponds to a person whose information the user wants to obtain;
second another person's ID transmitting means for transmitting another person's ID input from said second another person's ID inputting means, to said second another person's ID receiving means through said communication network;
information receiving means for receiving information transmitted from said information transmitting means of said server device in response to the transmission of another person's ID from said second another person's ID transmitting means; and
information outputting means for outputting information which said information receiving means receives.

2. The business card managing system according to claim 1, wherein:
each of the plurality of said second terminal devices further comprises:
user's own information inputting means for inputting information regarding the user; and
user's own information transmitting means for transmitting information regarding the user input from said user's own information inputting means, to said server device through said communication network,
said server device further comprises user's own information receiving means for receiving information regarding the user transmitted from said user's own information transmitting means,
said user's own information storing means stores information regarding the user which said user's own information receiving means receives, in connection with each user's ID.

3. The business card managing system according to claim 1, wherein:
each of the plurality of said first terminal devices further comprises another person's information inputting means for inputting information regarding another person whose ID the user obtained;
said first another person's ID transmitting means transmits information regarding another person input from said another person's information inputting means, together with the other person's ID;
said first another person's ID receiving means receives information regarding another person transmitted from said first another person's ID transmitting means, together with the other person's ID; and
said other persons' information storing means of the user whose first terminal device has transmitted the other person's ID, stores the other person's ID and information regarding the other person which said first another person's ID receiving means receives.

4. The business card managing system according to claim 1, wherein:
each of the plurality of said first terminal devices further comprises communication means for directly transmitting and receiving information to/from other first terminal devices; and
said first another person's ID inputting means inputs, as another person's ID which the user obtained, another person's ID which said communication means receives from the communication means of another first terminal device.

5. The business card managing system according to claim 1, wherein:
said server device further comprises ID transmitting means for transmitting an ID other than the user's, to one of the plurality of said first terminal devices through said communication network in response to the request; and
said first another person's ID inputting means inputs, as another person's ID which the user obtained, an ID transmitted form said ID transmitting means.

6. The business card managing system according to claim 1, wherein:
said second another person's ID transmitting means transmits the user's ID together with an input another person's ID;
said second another person's ID receiving means receives the user's ID together with the other person's ID; and
said information retrieving means retrieves information from said user's own information storing means and said other persons' information storing means which corresponds to the user's ID which said second another person's ID receiving means receives, in the case where the received other person's ID is stored in said other persons' information storing means.

7. The business card managing system according to claim 1, wherein:
said server device further comprises ID level storing means for storing another person's ID which each user obtains, in connection with an information disclosure level which the other person designates;
information regarding the user stored in said user's own information storing means is added with an information disclosure level; and
said information retrieving means searches said ID level storing means to retrieve information from said user's own information storing means, to the degree of an information disclosure level which corresponds to the received other person's ID.

8. The business card managing system according to claim 1, wherein:
said other persons' information storing means further stores a log that said information retrieving means retrieves and said information transmitting means transmits information, in connection with another person's ID,
each of the plurality of said second terminal devices further comprises:
log request transmitting means for transmitting a request for browsing a log that information regarding the user was referred to, to said server device through said communication network;
log receiving means for receiving the log transmitted from said server device in response to the request transmitted from said log request transmitting means; and
log outputting means for outputting the log which said log receiving means receives,
said server device further comprises:
log request receiving means for receiving the request transmitted from said log request transmitting means;
log acquiring means for acquiring the log which is stored in said other persons' information storing means of the other person, in connection with the user's ID corresponding to the request said log request receiving means received; and
log transmitting means for transmitting the log acquired by said log acquiring means, to said log receiving means through said communication network.

9. The business card managing system according to claim 1, wherein each of the plurality of said first terminal devices is constituted by a cellular phone.

10. The business card managing system according to claim 1, wherein each of the plurality of said first terminal devices is constituted by a computer device which is physically the same as the plurality of said second terminal devices.

11. A business card managing system which comprises a server device, and a plurality of first terminal devices and second terminal devices both of which are connected to said server device through a communication network, and at least one of each of which each user uses, wherein:
said server device comprises:
user's own information storing means for storing an ID of each user and information regarding the user;
first another person's ID receiving means for receiving another person's ID transmitted from said second terminal devices;
a plurality of other persons' information storing means which are respectively set up for each user and are for storing other persons' IDs which said first another person's ID receiving means receives, in connection with information regarding the other persons;
second another person's ID receiving means for receiving another persons' ID transmitted from one of said second terminal devices;
information retrieving means for retrieving information from said user's own information storing means which corresponds to another person's ID which said second another person's ID receiving means receives, and for retrieving information stored in said other persons' information storing means of the user in connection with the other person's ID; and
information transmitting means for transmitting information retrieved by said information retrieving means, to one of said second terminal devices that transmitted the other person's ID, through said communication network,
each of the plurality of said first terminal devices comprises:
first another person's ID inputting means for inputting another person's ID which each user obtains; and
other person's ID storing means for storing the other person's ID input from said first another person's ID inputting means, in a recording medium,
each of the plurality of said second terminal devices comprises:
another person's ID reading out means for reading out another person's ID stored in said recording medium;
first another person's ID transmitting means for transmitting the other person's ID read out by said another person's ID reading out means, to said first another person's ID receiving means through said communication network;
second another person's ID inputting means for inputting another person's ID which corresponds to a person whose information the user wants to obtain;
second another person's ID transmitting means for transmitting another person's ID input from said second another person's ID inputting means, to said second another person's ID receiving means through said communication network;
information receiving means for receiving information transmitted from said information transmitting means of said server device in response to the transmission of another person's ID from said second another person's ID transmitting means; and
information outputting means for outputting information which said information receiving means receives.

12. The business card managing system according to claim 11, wherein said second another person's ID inputting means inputs, as an ID of another person whose information the user wants to obtain, another person's ID read out by said another person's ID reading out means.

13. The business card managing system according to claim 11, wherein:
said second another person's ID transmitting means transmits the user's ID together with the input other person's ID;
said second another person's ID receiving means receives the user's ID together with the other person's ID; and
said information retrieving means retrieves information from said user's own information storing means and said other persons' information storing means which corresponds to the user's ID which said second another person's ID receiving means receives, in the case where the received other person's ID is stored in said other persons' information storing means.

14. The business card managing system according to claim 11, wherein:
said server device further comprises ID level storing means for storing another person's ID which each user obtains, in connection with an information disclosure level which the other person designates;
information regarding the user stored in said user's own information storing means is added with an information disclosure level; and
said information retrieving means searches said ID level storing means to retrieve information from said user's own information storing means, to the degree of an information disclosure level which corresponds to the received other person's ID.

15. The business card managing system according to claim 11, wherein:
said other persons' information storing means further stores a log that said information retrieving means retrieves and said information transmitting means transmits information, in connection with another person's ID,
each of the plurality of said second terminal devices further comprises:
log request transmitting means for transmitting a request for browsing a log that information regarding the user was referred to, to said server device through said communication network;
log receiving means for receiving the log transmitted from said server device in response to the request transmitted from said log request transmitting means; and
log outputting means for outputting the log which said log receiving means receives,
said server device further comprises:
log request receiving means for receiving the request transmitted from said log request transmitting means;
log acquiring means for acquiring the log which is stored in said other persons' information storing means of the other person, in connection with the user's ID corresponding to the request said log request receiving means received; and
log transmitting means for transmitting the log acquired by said log acquiring means, to said log receiving means through said communication network.

16. The business card managing system according to claim 11, wherein each of the plurality of said first terminal devices is constituted by a cellular phone.

17. The business card managing system according to claim 11, wherein each of the plurality of said first terminal devices is constituted by a computer device which is physically the same as the plurality of said second terminal devices.

18. A business card managing method which uses a communication network, comprising:
first step of registering each user's information in connection with the user's ID, in a server device through said communication network;
second step of registering another person's ID obtained from him/her, in said server device through said communication network;
third step of transmitting the other person's ID obtained from him/her, to said server device through said communication network, in order to request to browse information regarding the other person which corresponds to the other person's ID;
fourth step of extracting information regarding the other person which is requested to be browsed, from information which the other person registered as the information regarding himself/herself in said first step, according to the other person's ID, when said server device receives the other person's ID transmitted in said third step;
fifth step of transmitting information regarding the other person extracted in said fourth step, from said server device to the user who requested to browse through said communication network; and
sixth step of outputting information regarding the other person in order to be browsed by the user who requested to browse, when the user received the information in said fifth step.

19. The business card managing method according to claim 18, wherein:
said second step registers information regarding the other person in said server device, together with the other person's ID; and
said fourth step further extracts information registered as information regarding the other person in said second step, according to the other person's ID which said server device received in response to the request of said third step.

20. A business card managing method by which persons who confront each other can manage respective information, comprising:
previously storing information regarding each person in connection with the person's D in a database;
exchanging their IDs each other in the case they meet; and
accessing said database by using the ID obtained from the other person and obtaining information regarding the other person from said database.

21. The business card managing method according to claim 20, further comprising storing the exchanged IDs in said database in connection with each other, wherein
in the case where obtaining information regarding the other person from said database, the user's own ID is further used.

22. The business card managing method according to claim 20, further comprising storing the situation where the person obtained the ID in said database, at the time when obtaining the ID from the other person, wherein
in the case where obtaining information regarding the other person from said database, the situation where the person obtained the other person's ID is also obtained.

23. The business card managing method according to claim 20, wherein:
information regarding the person stored in said database can be renewed; and
in the case where obtaining information regarding the other person from said database, the latest renewed information can be obtained.

24. The business card managing method according to claim 20, wherein:
each of the items contained in the information regarding the person is designated a disclosure level and stored in said database with the disclosure level;
in the case where exchanging IDs, a disclosure level is selected according to the other person; and
in the case where obtaining information regarding the other person from said database, information corresponding to the selected disclosure level can be obtained.

25. The business card managing method according to claim 20, wherein:
each of the items contained in the information regarding the person is designated whether or not to be provided to the agent of the other person with whom the person exchanged IDs, and stored in said database with the designation; and
in the case where obtaining information regarding the other person from said database, information designated to be provided to the agent can only be obtained by the agent.

26. The business card managing method according to claim 20, further comprising:
storing a log that information regarding the person was obtained from said database in said database; and
each person referring to a log that information regarding the person was obtained from said database.

27. The business card managing method according to claim 20, wherein exchanging the IDs is implemented when each person meets the other person and exchanges their business cards in the business scene.

28. A server device which is connected to a plurality of terminal devices, each of which is used by a user for requesting information regarding another person, by transmitting the other person's ID, through a communication network, said server device comprising:
user's own information storing means for storing each user's ID and information regarding each user;
a plurality of other persons' information storing means which are respectively set up for each user for storing other persons' IDs which the user obtains, in connection with information regarding the other persons;
another person's ID receiving means for receiving another person's ID transmitted from one of said terminal devices;
information retrieving means for retrieving information from said user's own information storing means which corresponds to the other person's ID which said another person's ID receiving means receives, and for retrieving information stored in said other persons' information storing means of the user in connection with the other person's ID; and
information transmitting means for transmitting information retrieved by said information retrieving means, to said terminal device that transmitted the other person's ID through said communication network.

29. A client device which is connected to the server device as described in claim 28, and functions as one of said terminal devices, comprising:
another person's ID inputting means for inputting an ID of another person whose information the user wants to obtain;
another person's ID transmitting means for transmitting the other person's ID input from said another person's ID inputting means, to said another person's ID receiving means through said communication network;
information receiving means for receiving information transmitted from said information transmitting means of said server device in response to the transmission of the other person's ID from said another person's ID transmitting means; and
information outputting means for outputting information which said information receiving means receives.

30. A portable terminal device which is connected through a communication network to the server device as described in claim 28, comprising;
another person's ID inputting means for inputting another person's ID which the user obtains; and
another person's ID transmitting means for transmitting the other person's ID input from said another person's ID inputting means, to said server device through said communication network, and storing the ID in said other persons' information storing means.

31. A server device which is connected to a plurality of terminal devices, each of which is used by a user for requesting information regarding another person, by transmitting the other person's ID, through a communication network, wherein:
said server device comprises:
a user's own information database for storing each user's ID and information regarding each user;
a plurality of other persons' information databases which are respectively set up for each user and are for storing other persons' IDs which each user obtains in connection with information regarding the other persons;
a communication device for processing communications between itself and said terminal devices through said communication network;
a memory which stores a program; and
a processor for accessing said user's own information database and said other persons' information databases, and for controlling said communication device, according to the program stored in said memory,
said processor executes the program to:
wait until said communication device receives another person's ID from one of said terminal devices;
retrieve information from said user's own information database which corresponds to the other person's ID, in response to the reception of the other person's ID by said communication device;
retrieve information which is in connection with the received other person's ID, from said other persons' information database of the user; and
control said communication device to transmit information retrieved from said user's own information database and said other persons' information database, to said terminal device that transmitted the other person's ID through said communication network.

32. A client device which is connected to the server device as described in claim 31, and functions as one of said terminal devices, wherein:
said client device comprises:
an inputting device for inputting information;
an outputting device for outputting information;
a communication device for processing communications between itself and said server device through said communication network;
a memory which stores a program; and
a processor for controlling said inputting device, said outputting device and said communication device according to the program stored in said memory,
said processor executes the program to:
control said inputting device to input an ID of another person whose information the user wants to obtain;
control said communication device to transmit the other person's ID input from said inputting device, to said server device through said communication network;
wait until said communication device receives information transmitted from said server device in response to the transmission of the other person's ID; and
control said outputting device to output information which said communication device receives.

33. A portable terminal device which is connected through a communication network to the server device as described in claim 31, wherein:
said portable terminal device comprises:
an inputting device for inputting information;
a communication device for processing communications between itself and said server device through said communication network;
a memory which stores a program; and
a processor for controlling said inputting device, said outputting device and said communication device according to the program stored in said memory,
said processor executes the program to:
control said inputting device to input another person's ID which the user obtains; and
control said communication device to transmit the other person's ID input from said inputting device, to said server device through said communication network, in order to store the ID in said other persons' information database in said server device.

34. A computer-readable recording medium which stores a program, wherein the program controls a computer device which is connected to a plurality of terminal devices, each of which is used by a user for requesting information regarding another person by transmitting the other person's ID, through a communication network, to function as:
user's own information storing means for storing each user's ID and information regarding each user;
a plurality of other persons' information storing means which are respectively set up for each user and are for storing other persons' IDs which each user obtains, in connection with information regarding the other persons;
another person's ID receiving means for receiving another persons' ID transmitted from one of said terminal devices;
information retrieving means for retrieving information from said user's own information storing means which corresponds to the other person's ID which said another person's ID receiving means receives, and for retrieving information stored in said other persons' information storing means of the user in connection with the other person's ID; and
information transmitting means for transmitting information retrieved by said information retrieving means, to said terminal device that transmitted the other person's ID, through said communication network.

35. The computer-readable recording medium according to claim 34, wherein:
said recording medium further stores a program for controlling said computer device to function as user's own information receiving means for receiving information regarding each of the users of said terminal devices, transmitted from each of said terminal devices; and
said user's own information storing means stores information regarding each user which said user's own information receiving means receives, in connection with each user's ID.

36. The computer-readable recording medium according to claim 34, wherein in the case where said another person's ID receiving means receives the user's ID as well as the other person's ID, and the received other person's ID is stored in said other persons' information storing means of the user, said information retrieving means retrieves information from said user's own information storing means and said other persons' information storing means.

37. The computer-readable recording medium according to claim 34, wherein:
said recording medium further stores a program for controlling said computer device to function as ID level storing means for storing another person's ID which each user obtains, in connection with an information disclosure level which the other person designates;
information regarding the user stored in said user's own information storing means is added with an information disclosure level; and
said information retrieving means searches said ID level storing means to retrieve information from said user's own information storing means, to the degree of the information disclosure level which corresponds to the received other person's ID.

38. A computer-readable recording medium which stores a program, wherein the program controls a computer device which is connected to the server device as described in claim 28 through a communication network, to function as one of said terminal devices which comprise:
another person's ID inputting means for inputting an ID of another person whose information the user wants to obtain;
another person's ID transmitting means for transmitting the other person's ID input from said another person's ID inputting means, to said another person's ID receiving means through said communication network;
information receiving means for receiving information transmitted from said information transmitting means of said server device in response to the transmission of the other person's ID from said another person's ID transmitting means; and
information outputting means for outputting information which said information receiving means receives.

39. A computer-readable recording medium which stores a program, wherein the program controls a computer device which is connected to the server device as described in claim 28 through a communication network, to function as:
another person's ID inputting means for inputting another person's ID which the user obtains; and
another person's ID transmitting means for transmitting the other person's ID input from said another person's ID inputting means, to the business card managing server device through said communication network, and storing the other person's ID in said other persons' information storing means.

40. A carrier wave which superimposes a signaled program, wherein the program controls a computer device which is connected to a plurality of terminal devices, each of which is used by a user for requesting information regarding another person, by transmitting the other person's ID, through a communication network, to function as:
user's own information storing means for storing each user's ID and information regarding each user;
a plurality of other persons' information storing means which are respectively set up for each user and are for storing other persons' IDs which each user obtains, in connection with information regarding the other persons;
another person's ID receiving means for receiving another person's ID transmitted from one of said terminal devices;
information retrieving means for retrieving information from said user's own information storing means which corresponds to the other person's ID which said another person's ID receiving means receives, and for retrieving information stored in said other persons' information storing means of the user in connection with the other person's ID; and
information transmitting means for transmitting information retrieved by said information retrieving means, to said terminal device that transmitted the other person's ID, through said communication network.

41. The carrier wave according to claim 40, wherein:
the program further controls said computer device to function as user's own information receiving means for receiving information regarding each of the users of said terminal devices, transmitted from each of said terminal devices; and
said user's own information storing means stores information regarding each user which said user's own information receiving means receives, in connection with each user s ID.

42. The carrier wave according to claim 40, wherein in the case where said another person's ID receiving means receives the user's ID as well as the other person's ID, and the received other person's ID is stored in said other persons' information storing means of the user, said information retrieving means retrieves information from said user's own information storing means and said other persons' information storing means.

43. The carrier wave according to claim 40, wherein:
the program further controls said computer device to function as ID level storing means for storing another person's ID which each user obtains, in connection with an information disclosure level which the other person designates;
information regarding the user stored in said user's own information storing means is added with an information disclosure level; and
said information retrieving means searches said ID level storing means to retrieve information from said user's own information storing means, to the degree of the information disclosure level which corresponds to the received other person's ID.

44. A carrier wave which superimposes a signaled program wherein the program controls a computer device which is connected to the server device as described in claim 28 through a communication network, to function as one of said terminal devices which comprise:
another person's ID inputting means for inputting an ID of another person whose information the user wants to obtain;
another person's ID transmitting means for transmitting the other person's ID input from said another person's ID inputting means, to said another person's ID receiving means through said communication network;
information receiving means for receiving information transmitted from said information transmitting means of said server device in response to the transmission of the other person's ID from said another person's ID transmitting means; and
information outputting means for outputting information which said information receiving means receives.

45. A carrier wave which superimposes a signaled program wherein the program controls a computer device which is connected to the server device as described in claim 28 through a communication network, to function as:
another person's ID inputting means for inputting another person's ID which the user obtains; and
another person's ID transmitting means for transmitting the other person's ID input from said another person's ID inputting means, to the business card managing server device through said communication network, and storing the other person's ID in said other persons' information storing means.
